(19) United States
(12) Patent Application Publication
(10) Pub. No.: US 2005/0250496 A1
(43) Pub. Date: Nov. 10, 2005

(54) Communications methods and apparatus for use therein

(75) Inventors: Baruh Hason, Tel Aviv (IL); Salomon Serfaty, Doah Gaash (IL)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 10/515,448

(22) PCT Filed: Mar. 31, 2003
(86) PCT No.: PCT/EP03/03415

§ 371 Date: Nov. 22, 2004

(30) Foreign Application Priority Data
May 23, 2002 (GB) 0211824.8

(51) Int. Cl. H04Q 7/20

(52) U.S. Cl. 455/436; 455/426.1; 455/432.1

(57) ABSTRACT

A method and apparatus of operation of a mobile communication system comprising at least one mobile station is disclosed. The method and apparatus comprise storing in a database information relating to coverage areas of a plurality of wireless networks and monitoring the mobile station for its location while the mobile station is connected to a serving network. The method and apparatus then require comparing the monitored location of the mobile station with the stored coverage area information to produce an alert signal in the mobile station which indicates to the mobile station that one of the wireless networks is nearby. The method and apparatus then initiate a procedure to handover connectivity from the serving network to a nearby network, wherein the serving network and the nearby network use routing address protocols which have a common internet protocol (IP) address routing portion.

### FIELD OF THE INVENTION

The present invention relates to communications methods and apparatus for use therein. In particular it relates to methods and apparatus for use in for mobile communication systems.

### BACKGROUND OF THE INVENTION

Mobile units including a radio transceiver are also known in the art and referred to herein as mobile stations (MSs) and provide communications to other transceivers, either fixed or mobile via wireless links. The term ‘mobile station (MS)’ is intended to include within its meaning mobile and portable radio communication devices such as radios, radiotelephones, data terminals, palm pilots and the like, including such devices which are mobile by virtue of being carried on a moving vehicle. Systems or networks providing wireless communications to and from mobile stations are referred to herein as mobile communication systems.

There are various communication network kinds providing connectivity between devices operating within the network and to devices in other networks, especially MSs. For example, cellular radio networks and wireless local area networks (WLAN) are examples of two quite different network types which provide wireless data communications and connectivity on the one hand between terminals which are designed to operate within the network and on the other hand to worldwide data networks via the internet. Protocols exist to permit co-operation between networks of a similar kind but in general such protocols do not provide co-operation between network kinds such as cellular and WLAN which are quite different. This is not surprising, since network-to-network links involving these networks use different protocol layers. Links between cellular networks use a so-called layer 3 protocol whereas links between WLANs use a so-called layer 1 or layer 2 protocol which means that the two kinds of network are not designed to be compatible.

Forecasts show that in future uses, where a MS is within communication range of other terminals in both a cellular network and a WLAN, the available data rate, throughput and system capacity will favour use of the WLAN.

WLAN domains are localised coverage areas. A MS in a location outside a WLAN domain coverage area will receive wireless data services only via other systems, e.g. via a cellular network. However when the MS enters a WLAN domain, it is desirable for the MS to make external communications by radio attachment to the WLAN rather than to the cellular network. However, since no co-operation protocol exists between cellular and WLAN networks, a handover procedure in a manner similar to that employed between similar cellular networks is not possible. In consequence, in order to find a WLAN to which a MS could attach, it would be necessary for the MS to carry out a search for the existence of any nearby WLAN services. The existence of a nearby WLAN can be found by a MS for example by detection of a characteristic signal timing regime used in the WLAN. However such a search for the WLAN if carried out continuously will cause a significant undesirable drain of battery power, especially when no WLAN domain is nearby.

### SUMMARY OF THE PRESENT INVENTION

According to the present invention in a first aspect there is provided a method of operation of a mobile communication system including at least one mobile station (MS), which includes storing in a database information relating to the coverage area of a plurality of wireless networks, monitoring the location of the mobile station, comparing the monitored location of the mobile station with the stored coverage area information and producing an alert signal in the mobile station which indicates to the mobile station that one of the wireless networks is nearby.

The mobile communication system may comprise a cellular or trunked network. The network may for example operate according to the TETRA (Terrestrial Trunked Radio) standards laid down by ETSI (the European Telecommunications Standards Institute) or the GSM (Global System for Mobile communications) standards. One or more of the wireless networks whose coverage area information is stored may comprise a local area network such as a WLAN (Wireless connected Local Area Network). Alternatively, or in addition, one or more of the wireless networks whose coverage area information is stored may comprise one or more other local networks, e.g. a Bluetooth piconet or a Bluetooth scatternet or other PAN (personal area network).

When the said alert signal is produced in the MS, the MS may begin a search procedure to search for a local wireless network in the area. The said alert signal produced in the MS may indicate to the MS the kind of network, e.g. WLAN, which is nearby and to be searched for according to the information stored in the database. The generation of the alert signal may be such as to favour the search for a particular kind of network, e.g. a WLAN, rather than any other kind of network.

The said database may be included in a memory of a fixed installation in the infrastructure of the mobile communication network, e.g. in a controller, although it could be included in a memory of the MS itself.

In the method according to the invention, the location of the MS may be monitored in one of a number of ways, e.g. which are known per se.

For example, the MS may include or carry as an attachment a position monitor device such as a GPS (Global Positioning System) receiver which provides inputs to the MS about its position or location, e.g. as position co-ordinates. Messages about the monitored position or location of the MS may also be sent by the MS to the network infrastructure or a unit thereof.

Alternatively, the location may be determined by measuring the distance between the MS and each of a set of at least three separate base transceiver stations using time of arrival or time difference of arrival of signals sent between the mobile station and the transceiver stations. Such a procedure is described for example in GB-A-2368240. A unit of the infrastructure of the network, e.g. a network controller, may initiate this procedure.

As an additional alternative, the location of the MS may be determined by the mobile communication system, roughly, as the vicinity of a fixed installation (e.g. base station) with which the mobile station is directly conducting the wireless communication.

In general, the network that the mobile station is leaving and the one it is joining will both provide connectivity to other more global networks such as the internet, and a standard message characteristic of this global network, for example an e-mail, generated and sent using the global network protocol and address of the target device, e.g. controller of the new network, will allow communication between the two different networks to take place.

In the method according to the first aspect of the invention a handover procedure may be initiated when the MS detects that it is within range of one of the wireless networks, e.g. WLANs. In this case, when and if necessary, communication between (i) the MS and/or the infrastructure unit, e.g. controller, of the network the mobile station is leaving and (ii) an attachment unit, e.g. a controller, of the wireless network, e.g. WLAN, the MS is to join may be by use of a standard message sent using the overlaying global network, e.g. internet, protocol procedures. When the MS attaches to a new network, procedures such as the standard ones using SIP (Session Initiation Protocol), which is as described in the industry standard publication IETF RFC2543, for transferring a current data communication session to the new network may be begun. The feasibility and characteristics of such procedures depend on whether the handover uses the so-called ‘break before make’ method or the so-called ‘simultaneous connection’ method (by which there is a period during which the MS is connected to both networks).

In the case where the overlaying global network is conducted using internet protocol (IP), the handover procedure may be enhanced by arrangement between the operator of the first network which the MS is leaving and the operator of the second network (e.g. WLAN) that the MS is joining, that both-networks will use a common IP routing address portion, e.g. a common IP subnet routing domain. In this case, the MS its IP address when transferring from the first, e.g. cellular, network to the second network, e.g. WLAN. The MS can then inform the controller of the first network that it has attached to the second network. The transfer of any current IP communication whose destination or origin is the mobile station can thereby be continued in the second network.

According to the present invention in a second aspect there is provided a network controller which is useful in the method according to the first apsect which includes a coverage area database operable to store information relating to a plurality of other wireless networks, a processor for comparing information relating to the current location of one or more mobile stations operable in the network with stored coverage area information and operable to send a signal to one or more of the mobile stations which indicates to the mobile station or stations that one of the other wireless networks is nearby. This signal sent to the mobile station or stations may carry information similar to the alert signal of the first aspect.

According to the present invention in a third aspect there is provided a mobile station which is operable in the method according to the first aspect and which is operable to search for a wireless network when it has received an alert signal indicating that such a network is nearby. The alert signal if sent to the MS by the system infrastructure may carry information similar to the alert signal of the first aspect. The MS may be operable to hand over communications to the wireless network when it has detected a signal from the wireless network (e.g. WLAN).

The present invention beneficially allows networks such as WLANs, which can in some circumstances provide a superior data communication service to a MS to be detected without undue operating the MS in a continuous search mode with the undue consumption of power of the battery of the MS in such a mode.

Embodiments of the present invention will now be described by way of example with reference to the accompanying drawings, in which:

### BRIEF DESCRIPTION OF THE ACCOMPANYING DRAWINGS

FIGS. 1, 2 and 3 are schematic layout diagrams of alternative mobile communication network arrangements in which embodiments of the present invention are used.

FIG. 4 is a block circuit diagram of an example of a mobile station useful in the arrangements shown in FIGS. 1 to 3.

### DESCRIPTION OF EMBODIMENTS OF THE INVENTION

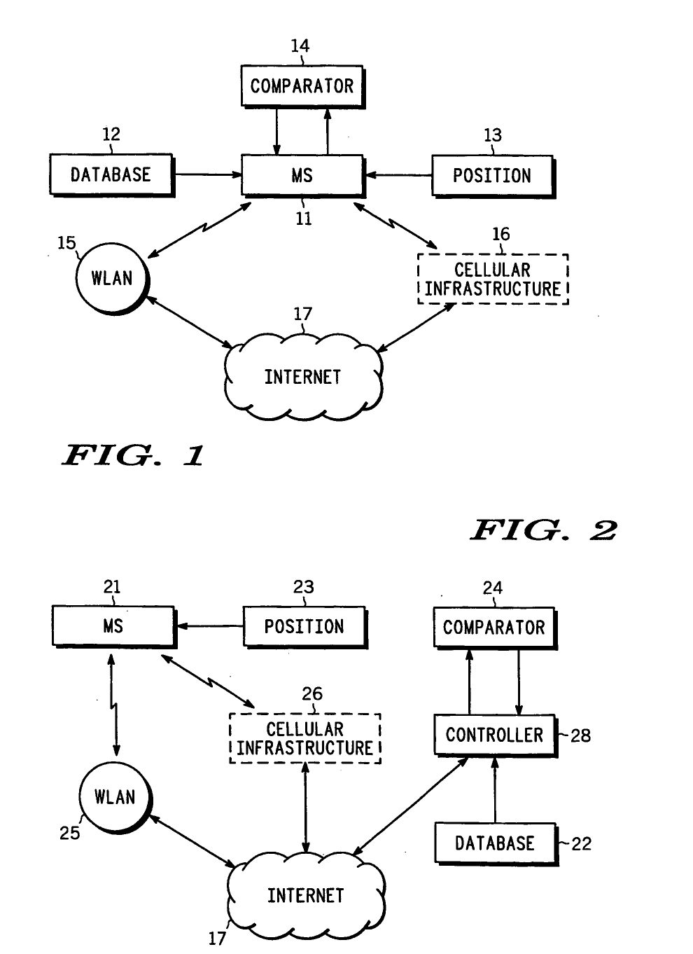

As shown in FIG. 1, a mobile station MS 11 is capable in a known manner of providing (when appropriate) two-way radio communication with (i) a cellular infrastructure 16 (one or more fixed installation components of a cellular network, e.g. including a base transceiver station) and a (ii) a WLAN 15. In addition, the MS 11 is equipped with (i) a position monitoring device 13, such as a GPS device; which determines the position of the MS 11; (ii) a database 12, which stores a list of coverage areas for all known WLAN networks, such as the WLAN 5, in a given region; and (iii) a comparator 14, which determines whether the position determined from the device 13 is within the geographical boundary of any of the coverage areas as indicated by the coverage area information stored in the database 12. In practice, the device 13 may be a separate component of or attachment to the MS 11 and the database 12 and the comparator 14 may be part of a processor within the MS, e.g. part of a function controller device, e.g. a digital signal processor, of the MS. Both the cellular infrastructure 16 and the WLAN 15 have connections of a known kind to an overlaying network, i.e. the Internet 17. The MS 11 is capable of using services of the Internet 17 via either the cellular infrastructure 16 and the WLAN 15.

When the comparator 14 finds a match between the position of the MS 11 determined by the device 13 and the information in the database 12 it generates an alert signal for use within the MS 11. This signal triggers the MS 11 to begin a handover procedure involving initially a search by the MS 11 for the WLAN 12. Subsequently, when a communication link between the MS 11 and WLAN 12 has been detected, handover of the MS 11 from the cellular infrastructure 16 to the WLAN 15 is initiated and carried out in one of the ways described earlier. Such handover may be controlled in the MS 11 by a controller, e.g. digital signal processor, which may be the same controller providing the function of the comparator 14.

In the alternative arrangement shown in FIG. 2, a MS 21 is capable of two-way radio communication with a cellular infrastructure 26 and when appropriate with a WLAN 25. In addition, the MS 21 is equipped with a position monitoring device 23, which determines the position of the MS 21. A database 22, which stores a list of coverage areas for all known WLANs (including the WLAN 25) in a given region, and a comparator 24 operating in a manner similar to the comparator 14 (FIG. 1) are provided in a location, e.g. a fixed location, external to each of the MS 21, the cellular infrastructure 26 and the WLAN 25 and they are controlled by a controller 28. The database 22, the comparator 24 and the controller 28 operate together in a manner similar to the database 12, comparator 14 and controller of the MS 1 described with reference to FIG. 1.

In operation of the arrangement shown in FIG. 2, information indicating the position of the MS 1 as determined by the device 23 is passed by the device 23 to the MS 21 and is sent from time-to-time in communication signals by the MS 21 to the controller 28. This communication is via the cellular infrastructure 26 and the overlaying network services provided by the Internet 17. When the controller 28 has received the information indicating the position of the MS 21, it provides the information to the comparator 24 together with coverage area information from the database 22. The comparator 24 looks for a match between the position and the coverage area information in a manner similar to the comparator 14 of FIG. 1. If the comparator 24 finds a match it triggers generation by the controller 28 of a signal, which is sent by the controller 28 to the cellular infrastructure 26 via the Internet 27 and thence to the MS 21 by the cellular infrastructure 26. This signal in turn, triggers the production of an alert signal in the MS 21 which initiates a handover search and execution procedure resulting in handover of the MS 21 to the WLAN 25 as described earlier and with reference to FIG. 1.

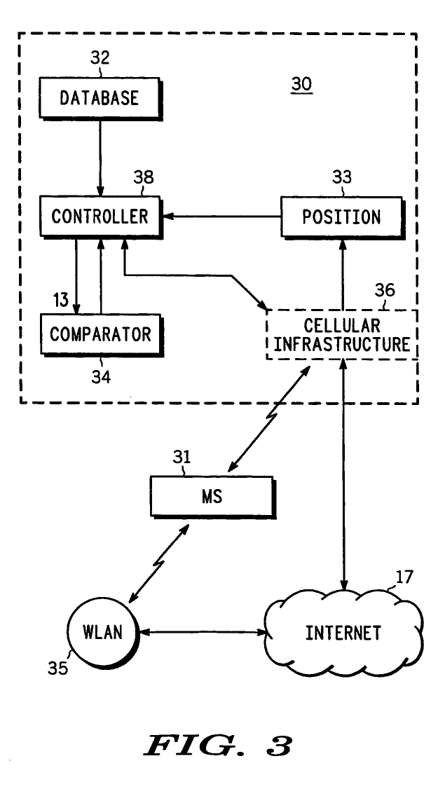

FIG. 3 shows a further alternative arrangement embodying the present invention. In this case, a database 32, a comparator 34 and a controller 38 operate together in a manner similar to the database 12, the comparator 14 and controller of the MS 11 as described with reference to FIG. 1. In the case of the FIG. 3 arrangement, the database 32, the comparator 34 and the controller 34 are all included within a network control installation 30, which also includes a cellular infrastructure 36 similar to the infrastructure 16 (FIG. 1). A position monitoring device 33 in the installation 30 receives inputs from the cellular infrastructure 36 comprising information indicating the position of the MS 31, e.g. as determined by TDOA, and thereby monitors the position of a MS 31. The controller 34 provides this position information together with coverage area information from the database 32 to the comparator 34. If a match is found by the comparator 34 between the position of the MS 31 and the information relating to the coverage area of a WLAN 35, a signal is generated by the controller 38 and is sent to the MS 31 using the messaging services of the cellular infrastructure 36. When this signal is received by the MS 31, it triggers an alert signal which initiates a search procedure and subsequently executes a handover of the MS 1 to the WLAN 5 in one of the ways described earlier.

In the embodiments illustrated in FIGS. 1, 2 and 3 the internet connection of the WLAN (e.g. WLAN 15) and the cellular infrastructure (e.g. cellular infrastructure 16) may be achieved under the same subnet, in which case there is no change of IP address in the MS (e.g. MS 11), as explained earlier.

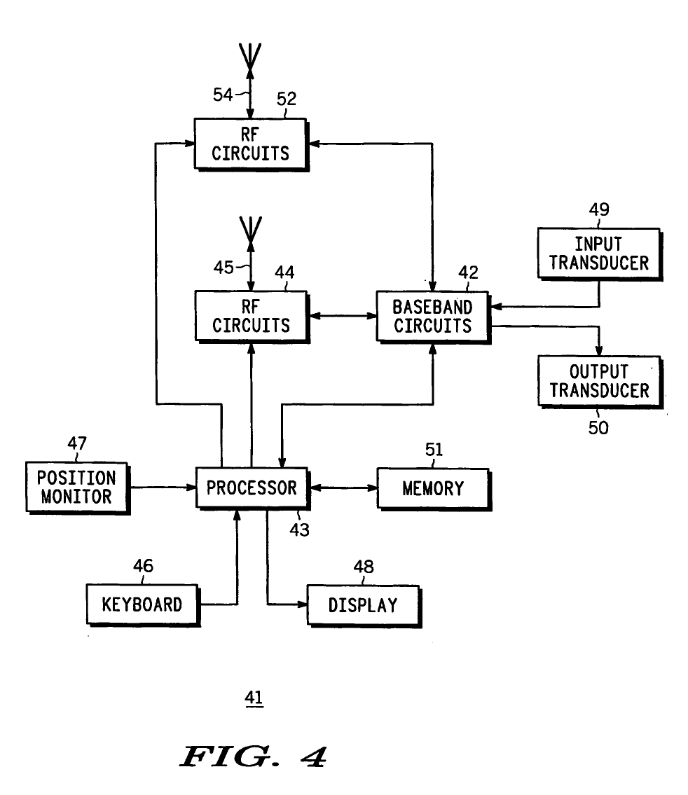

FIG. 4 is a schematic block circuit diagram showing more detail of an example of an MS suitable for use in the embodiments described with reference to FIGS. 1 to 3. The MS labelled 41 includes a processor 43, such as provided by one or more digital signal processors, which controls operational functions of the MS 41, i.e. it acts as the controller (as referred to earlier with reference to FIG. 1). The processor 43 receives user input controls from a keyboard 46. Inward and outward communication signals to and from a terminal in a first network, e.g. a cellular network, are transmitted and received by an antenna 45 and are processed in a known manner by baseband circuits 42 and R.F. circuits 44 both operating under control of the processor 43. The R.F. circuits 44 are connected to the antenna 45. Outputs from the baseband circuits 42 (received signals which have been processed) are provided to an output transducer 49, which may for example be a speaker or a modem connection to a data processor (e.g. personal computer). Likewise, inputs (signals to be transmitted to the first network) are provided from an input transducer 50, e.g. a microphone or a modem connected to a data processor, to the baseband circuits 42 and are processed by the baseband circuits 42 and R.F. circuits 44 and then transmitted by the antenna 45.

Inward and outward communication signals to and from a terminal in a second (local) network, e.g. a WLAN, are transmitted and received by an antenna 54 and are processed in a known manner by baseband circuits 42 and R.F. circuits 52 both operating under control of the processor 43. The R.F. circuits 52 are connected to the antenna 54. Outputs from the baseband circuits 42 (received signals which have been processed) are again provided to the output transducer 49. Likewise, inputs (signals to be transmitted to the second network) are again provided from the input transducer 50, to the baseband circuits 42 and are processed by the baseband circuits 42 and R.F. circuits 52 and then transmitted by the antenna 54.

The processor 43 is connected to a memory 51 which serves as a coverage area database in the manner of the database 12 of FIG. 1, from which the processor 43 can access stored information. The processor 43 is also connected to a display 43 to indicate visual information to the user. A position monitoring device 47 (an optional component of the MS used only in some of the above embodiments) is connected to the processor 31 and provides input signals indicating the position co-ordinates of the MS 41 in the manner of the position monitor device 13 in FIG. 1. The processor 43 constructs signals to send via the RF circuits 44 and the antenna 45 to a cellular infrastructure, e.g. the infrastructure 16 of FIG. 1, and when appropriate via the RF circuits 52 and antenna 54 to a WLAN such as the WLAN 15 of FIG. 1.

As will be apparent to those skilled in the art, various alternative forms of the MS 41 shown in FIG. 4 are possible. For example, the baseband circuits 42 may be incorporated as part of the processor 43. The MS itself may act as its own data source and data sink in which case the transducers 39 and 41 will not be required.

The processor 43 of the MS 41 controls operation of the MS 41 to be suitable for communication when appropriate with (i) a cellular or trunked network, e.g. a TETRA network, and (ii) a local network such as a WLAN or a Bluetooth net; by appropriate use of the RF circuits 44 and antenna 45 or the RF circuits 52 and antenna 54. The processor 43 also provides control of the operational functions related to search for and handover to the latter network (ii) from the former (i).

Differences exist between the communication protocols and operation required for use by the MS 41 for communication in a first mode between the MS 41 and the first network, e.g. cellular or trunked network, on the one hand, and in a second mode between the MS 41 and the second network, e.g. WLAN, on the other hand. Such differences will require implementation differences in the following parts of the MS 41:
(i) the antenna
(ii) the RF circuits,
(iii) the baseband circuits; and
(iv) higher layer protocol handling in the central processor or controller (processor 43).

As a result, separate circuitry and processing units are needed in principle to implement the first and second modes. The common and unified treatment starts at the common overlaying network protocol, e.g. the internet protocol (IP) layer. In practice, whether or not separate components are required for the different modes of communication will be determined by the actual form of implementation employed. For example, a common baseband circuitry unit can serve both WLAN and cellular communications in the manner of the baseband circuits 42 as shown in FIG. 4 and a single common processor or set of processors can handle different protocols as illustrated with reference to the processor 43 with reference to FIG. 4.

Furthermore, if simultaneous operation in two modes is required by the MS, an implementation arrangement which can provide such simultaneous operation is needed. Such arrangements are known per se.

1. A method of operation of a mobile communication system comprising at least one mobile station, the method comprising
storing in a database information relating to coverage areas of a plurality of wireless networks,
monitoring a location of the mobile station when the mobile station is connected to a serving network,
comparing the monitored location of the mobile station with the stored coverage area information,
producing an alert signal in the mobile station which indicates to the mobile station that one of the wireless networks is nearby, and
initiating a procedure to handover connectivity from the serving network to a nearby network, wherein the serving network and the nearby network use routing address protocols which have a common internet protocol (IP) address routing portion.

2. The method according to claim 1 wherein the mobile communication system further comprises a cellular or trunked network.

3. The method according to claim 2 wherein the mobile communication system is a trunked network operable according to TETRA (Terrestrial Trunked Radio) standards laid down by ETSI (the European Telecommunications Standards Institute).

4. The method according to claim 2 wherein the mobile communication system is a GSM (Global System for Mobile communications) network.

5. The method according to claim 1 wherein one of the wireless networks comprises a WLAN (wireless connected local area network).

6. The method according to claim 1 wherein one of the wireless networks comprises a Bluetooth piconet or scatternet or a PAN (Personal Area Network) of another kind.

7. The method according to claim 1 wherein when the alert signal has been produced in the mobile station, the mobile station begins a search procedure to search for a local wireless network in the area.

8. The method according to claim 7 wherein the alert signal indicates to the mobile station a kind of network which is nearby and is to be searched for according to the stored coverage area information.

9. The method according to claim 1 wherein the database is included in a memory of a fixed installation, external to the mobile communication system.

10. The method according to any one of claim 1, wherein the database is included in a memory of a fixed installation of the mobile communication system.

11. The method according to claim 10 wherein the fixed installation comprises a controller unit.

12. The method according to claim 1 wherein the database is included in a memory of the mobile station.

13. (canceled)

14. The method according to claim 1 further comprising
wherein the database is included in a memory of a controller of the mobile communication system or a fixed installation external to the mobile communication system, and
wherein the mobile station is operable to send messages comprising information about its location directly or indirectly to the controller, and the controller or a comparator associated therewith, is operable to compare the location information it receives from the mobile station with that relating to the stored coverage area information stored in the memory.

15. (canceled)

16. (canceled)

17. (canceled)

18. (canceled)

19. A The method according to claim 1 wherein the procedure comprises a search by the mobile station for a local wireless network and, when signals from the local wireless network have been detected, executing handover of communications of the mobile station to the local wireless network.

20. The method according to claim 14 further comprising wherein communication between: (i) the mobile station and/or an infrastructure unit of the mobile communication system which the mobile station is leaving; and (ii) a control unit of the local wireless network the mobile station is to join; is by use of a message sent using an overlaying network protocol procedure.

21. The method according to claim 20 wherein the overlaying network protocol procedure comprises an internet protocol procedure.

22. A network controller adapted to perform the method of claim 1.

23. (canceled)

24. The method of claim 1 wherein the mobile station is operable to search for a wireless network when it has received an alert signal indicating that such a wireless network is nearby and to initiate connectivity handover using an internet protocol (IP) address routing portion in its address which is recognised in the serving network and in another wireless network.

25. The method of claim 24 wherein the mobile station is operable to hand over communications to the wireless network when it has detected a signal from the wireless network or fixed installation external to the wireless network.

26. The method of claim 1 wherein the mobile station informs a controller of the serving network that the mobile station has attached to the nearby network.

27. The method of claim 1 wherein a current IP communication whose destination is the mobile station in the serving network is transferred to the mobile station as destination in the nearby network.
